(19) United States
(12) Patent Application Publication
(10) Pub. No.: US 2024/0409242 A1
(43) Pub. Date: Dec. 12, 2024

(54) SPACE VEHICLE HEAT DISSIPATION SYSTEMS

(71) Applicant: NETWORK ACCESS ASSOCIATES LIMITED, London (GB)

(72) Inventors: Victor COLAS, London (GB); Manraj NAGI, London (GB)

(21) Appl. No.: 18/812,140

(22) Filed: Aug. 22, 2024

Related U.S. Application Data
(63) Continuation of application No. PCT/IB2023/000117, filed on Feb. 24, 2023.

(30) Foreign Application Priority Data
Feb. 25, 2022 (FR) 2201689

(51) Int. Cl. B64G 1/50; B82Y 40/00

(52) U.S. Cl. CPC B64G 1/503; B64G 1/506; B82Y 40/00

(57) ABSTRACT

A space vehicle including a space vehicle body, wherein the space vehicle body includes an interior surface defining an interior of the space vehicle body and an exterior surface opposite the interior surface, and wherein at least a portion of the space vehicle body comprises a panel comprising a sheet metal; an onboard equipment component positioned within the interior of the space vehicle body; a radiator positioned on the exterior surface of the space vehicle body, wherein the radiator includes a plurality of corrugations, and wherein the plurality of corrugations are angled so as to reflect at least a portion of incident sunlight away from Earth; and a heat transport element positioned along the interior surface of the space vehicle body so as to convey heat away from the onboard equipment component and toward the radiator.

### FIELD OF THE INVENTION

The field of the invention relates to space vehicle thermal management systems and methods for manufacturing such vehicles and systems. More particularly, the field invention relates to space vehicles, such as satellites, having outer shells formed from stamped panels, in which thermal management elements are integrally formed with such outer shells or are mounted on such outer shells.

### BACKGROUND OF THE INVENTION

Conventional radiators used in space vehicles, such as satellites, have flat surfaces. Such radiators are often covered by coating materials having desired thermo-optical properties.

### BRIEF DESCRIPTION OF THE FIGURES

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 shows a perspective view of an exemplary space vehicle.

FIG. 2 shows a perspective view of an exemplary space vehicle.

FIG. 3 shows a perspective view of a panel of an exemplary space vehicle.

FIG. 4 shows an exploded perspective view of panels of an exemplary space vehicle.

FIG. 5 shows an exploded perspective view of panels of an exemplary space vehicle.

FIG. 6 shows elements of an exemplary space vehicle.

FIG. 7 shows elements of an exemplary space vehicle including stamped grooves and heat pipes.

FIG. 8A shows a perspective view of elements of an exemplary space vehicle including stamped grooves that are shaped to receive heat pipes.

FIG. 8B shows a top view of the elements of the exemplary space vehicle shown in FIG. 8A.

FIG. 9 shows a cross-section of an exemplary radiator corrugation.

FIG. 10 shows a cross-section of an exemplary radiator corrugation.

FIG. 11 shows a cross-section of an exemplary panel corrugation.

FIG. 12 shows a perspective view of an exemplary corrugated radiator

FIG. 13A shows a perspective view of an exemplary space vehicle including corrugated radiators.

FIG. 13B shows a detailed perspective view of a portion of the space vehicle of FIG. 13A.

FIG. 14 shows an exemplary corrugation.

FIG. 15A shows sunlight incident on a flat reflective surface.

FIG. 15B shows sunlight incident on an exemplary corrugated radiator.

FIG. 15C shows an alternate view of sunlight incident on the exemplary corrugated radiator of FIG. 15B.

FIG. 16A shows an exemplary pattern of an exemplary corrugated radiator.

FIG. 16B shows an exemplary pattern of an exemplary corrugated radiator.

### SUMMARY OF THE INVENTION

In some embodiments, a space vehicle includes an upper panel; a lower panel fixed to the upper panel around at least a portion of respective perimeters thereof to thereby form an enclosed structure having an interior volume; two stacking pillars at opposite sides of the enclosed structure; a stiffener extending across the interior volume, wherein the stiffener is fixed to the upper panel and the lower panel, and wherein the stiffener extends from a first end proximate a first one of the two stacking rings to a second end proximate a second one of the two stacking rings; and a plurality of payload elements, wherein each of the plurality of payload elements is fixed to at least one of the upper panel, the lower panel, or the stiffener, and wherein at least some of the plurality of payload elements lack a casing.

In some embodiments, the upper panel and the lower panel are fabricated by press-forming.

In some embodiments, a space vehicle includes a space vehicle body, wherein the space vehicle body includes an interior surface defining an interior of the space vehicle body and an exterior surface opposite the interior surface, and wherein at least a portion of the space vehicle body comprises a panel comprising a sheet metal; an onboard equipment component positioned within the interior of the space vehicle body; a radiator positioned on the exterior surface of the space vehicle body, wherein the radiator includes a plurality of corrugations, and wherein the plurality of corrugations are angled so as to reflect at least a portion of incident sunlight away from Earth; and a heat transport element positioned along the interior surface of the space vehicle body so as to convey heat away from the onboard equipment component and toward the radiator.

In some embodiments, the heat transport element is oriented transversely to the plurality of corrugations of the radiator.

In some embodiments, the heat transport element is oriented along the plurality of corrugations of the radiator.

In some embodiments, the heat transport element is positioned within one of the plurality of corrugations of the radiator.

In some embodiments, the heat transport element is defined by a material of the radiator and a material of the panel underlying the material of the radiator. In some embodiments, the heat transport element also includes a heat-conductive liquid positioned within a space defined between the material of the radiator and the material of the panel. In some embodiments, the heat-conductive liquid has a thermal conductivity greater than 0.2 W/m K at standard temperature and pressure. In some embodiments, the heat-conductive liquid comprises ammonia.

In some embodiments, the heat transport element comprises a heat pipe. In some embodiments, the heat pipe comprises at least one of a copper-water heat pipe, a carbon-ammonia heat pipe, or an aluminum-ammonia heat pipe.

In some embodiments, the heat transport element comprises a carbon nanotube-based material.

In some embodiments, the heat transport element has a heat flux density that is in a range of from 2 W/m² to 20 W/m².

In some embodiments, the heat transport element has a thermal conductivity that is at least 1,000 W/m/K.

In some embodiments, the heat transport element has a heat transport capacity that is a range of from 10 W to 1,000 W.

In some embodiments, the space vehicle also includes a conductive filler positioned between the heat transport element and the interior surface of the space vehicle body so as to adhere the heat transport element to the interior surface of the space vehicle body. In some embodiments, the conductive filler has a thermal conductivity that is in a range of from 100 W/m/K to 1,000 W/m/K in plane.

In some embodiments, the plurality of corrugations are further angled so as to reduce a proportion of incident sunlight that shines on the radiator.

In some embodiments, the onboard equipment component is one of a platform equipment component or a payload component.

### DETAILED DESCRIPTION OF THE INVENTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It will be understood that various changes may be made in the function and arrangement of elements without departing from the spirit and scope of the presently disclosed embodiments. Embodiment examples are described as follows with reference to the figures. Identical, similar, or identically acting elements in the various figures are identified with identical reference numbers and a repeated description of these elements is omitted in part to avoid redundancies.

Throughout the specification, the following terms take the meanings explicitly associated herein, unless the context clearly dictates otherwise. The phrases “in one embodiment” and “in some embodiments” as used herein do not necessarily refer to the same embodiment(s), though they may. Furthermore, the phrases “in another embodiment” and “in some other embodiments” as used herein do not necessarily refer to a different embodiment, although they may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or,” or with the conjunction “and.” In either case, the set is to be interpreted as meaning each of the items singularly as alternatives, as well as any combination of the listed items.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The exemplary embodiments described herein relate to radiators for space vehicles, such as satellites. More particularly, the exemplary embodiments described herein relate to corrugated radiators for space vehicles. The exemplary embodiments also relate to space vehicles having corrugated radiators directly overlaying heat transport elements, such as heat pipes.

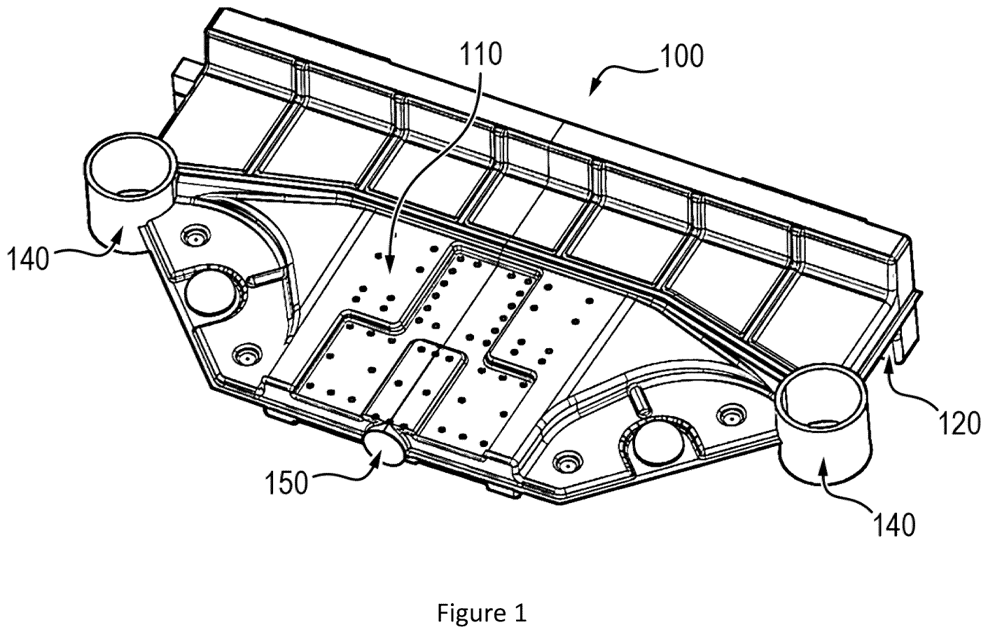

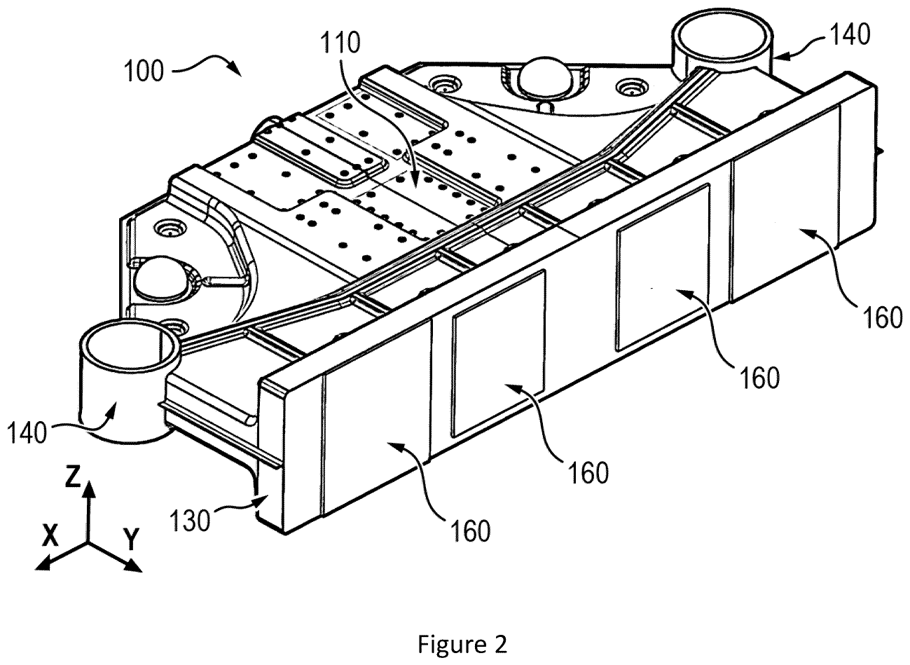

FIGS. 1 and 2 show perspective views of opposite sides of an exemplary space vehicle 100. In some embodiments, an exemplary space vehicle 100 includes two panels 110, 120 forming an outer shell of the space vehicle 100. In some embodiments, the first and second panels 110, 120 are not honeycomb panels. In some embodiments, the first and second panels 110, 120 includes a metal. In some embodiments, the panels 110, 120 include a metal alloy. In some embodiments, the metal alloy includes at least one of an aluminum alloy, a steel alloy, and/or combinations thereof. In some embodiments, the panels 110, 120 include an aluminum alloy. In some embodiments, the aluminum alloy includes aluminum and zinc. In some embodiments, the aluminum alloy is a 7000-series aluminum alloy. In some embodiments, the aluminum alloy is 7075 aluminum. In some embodiments, the panels 110, 120 are press-formed. In some embodiments, the panels 110, 120 are press-formed from sheet aluminum. In some embodiments, the metal alloy includes an alloy other than steel and/or aluminum. In some embodiments, the panels 110, 120 include a composite. In some embodiments, the panels 110, 120 include a fiber composite. In some embodiments, the fiber composite includes at least one of a carbon fiber composite and/or a glass fiber composite.

In some embodiments, the sheet aluminum has a thickness that is from 0.1 millimeter to 10 millimeters. In some embodiments, the sheet aluminum has a thickness that is from 0.1 millimeter to 1 millimeter. In some embodiments, the sheet aluminum has a thickness that is from 1 millimeter to 3 millimeters. In some embodiments, the sheet aluminum has a thickness that is from 3 millimeters to 5 millimeters. In some embodiments, the sheet aluminum has a thickness that is from 5 millimeters to 10 millimeters. In some embodiments, the sheet aluminum is 1 millimeter in thickness. In some embodiments, the sheet aluminum is 2 millimeters in thickness. In some embodiments, the sheet aluminum has a first thickness (e.g., 0.1 millimeter) in some regions and has one or more regions having a greater second thickness (e.g., 2 millimeters) provided by the addition of a corresponding thickening panel or panels.

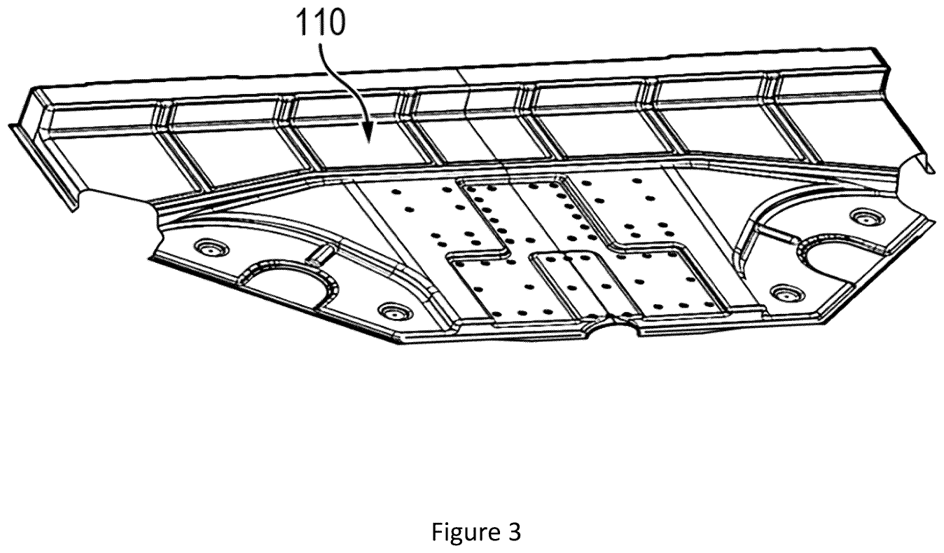

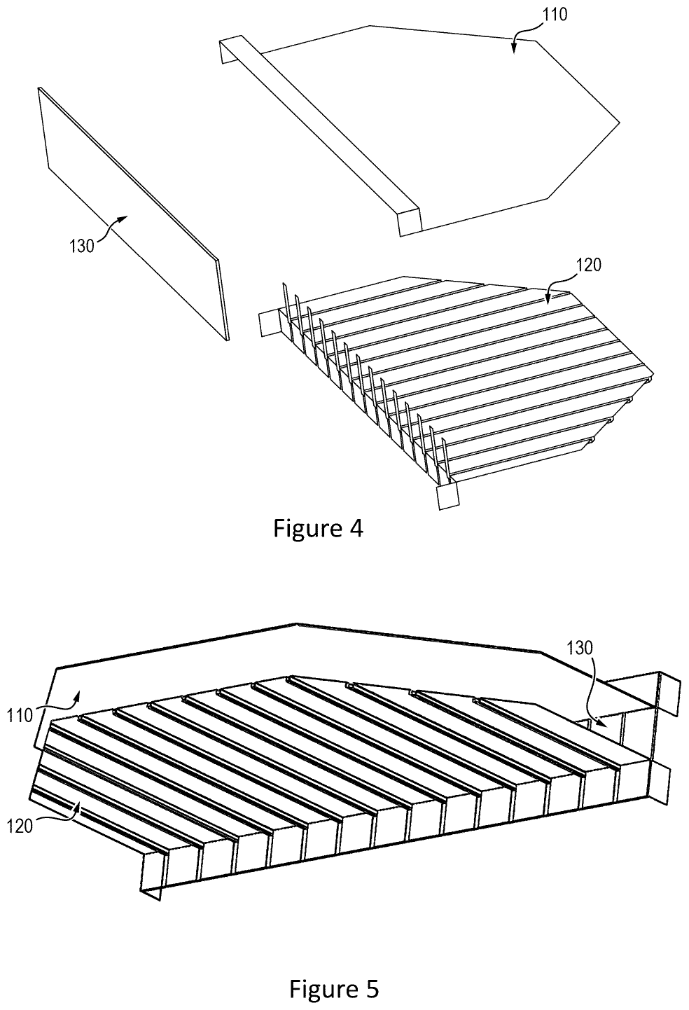

In some embodiments, the panels 110, 120 are joined to one another around the respective perimeters thereof to form an enclosed structure. In some embodiments, the panels 110, 120 are connected by a mechanical joining technique such as welding, joining with fasteners (e.g., bolts, rivets, etc.), or adhering (e.g., with a glue or other adhesive). FIG. 3 shows an exploded perspective view of the exemplary panel 110. FIG. 4 shows an exploded perspective view of the exemplary panels 110 and 120, together with an earth deck panel 130 that is configured to be positioned at a location of the space vehicle 100 that faces toward Earth when the space vehicle 100 is in orbit. FIG. 5 shows an additional perspective view of the panels 110 and 120 and the earth deck panel 130.

Referring back to FIGS. 1 and 2, in some embodiments, the exterior of the space vehicle 100 includes one or more stacking pillars 140, a solar array mounting interface 150, and one or more antenna modules 160 (e.g., transmitting antenna modules and receiving antenna modules). In some embodiments, the one or more stacking pillars 140 includes two stacking pillars 140. In some embodiments, respective pass-throughs are formed in the panels 110, 120 to allow external elements of the space vehicle 100 to be coupled (e.g., communicatively) to internal elements of the space vehicle 100.

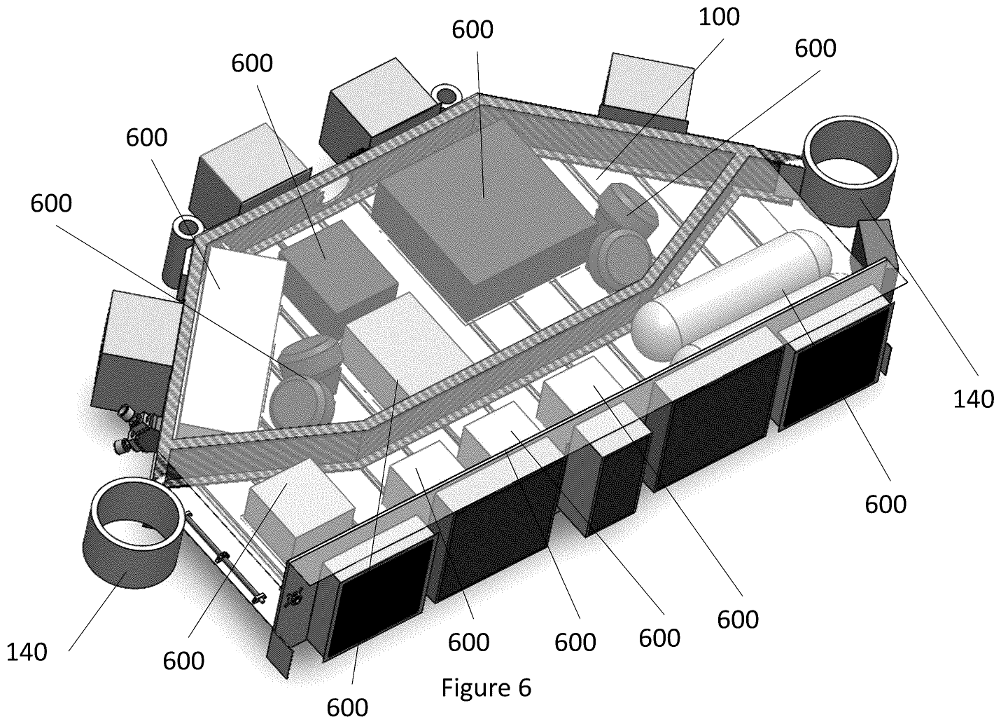

In some embodiments, an exemplary space vehicle 100 includes onboard equipment, such as platform equipment and payloads. FIG. 6 shows an exemplary space vehicle 100 including various onboard equipment 600, such as platform equipment and payloads, positioned at various locations therein. In some embodiments, exemplary onboard equipment includes an on-board computer, a power conditioning and distribution unit, an on-board processor, an optical head, an optical terminal, one or more reaction wheels, a power processing unit, one or more gateway interface units, and/or a battery. The specific equipment listed above is only exemplary, and the equipment that will be included in the exemplary space vehicle 100 will vary among different implementations. Additionally, the specific locations of the onboard equipment 600 shown in FIG. 6 are only exemplary, and the specific locations of onboard equipment 600 will vary among different implementations. In some embodiments, at least some items of the onboard equipment 600 have their respective casings removed and are mounted within the exemplary space vehicle by mounting directly to one of the panels.

In some embodiments, an exemplary space vehicle includes an upper panel and a lower panel that are attached to one another to form an enclosed body within which platform hardware and payloads are accommodated. In some embodiments, the interior of an exemplary space vehicle (e.g., an interior space as defined between two joined panels) is pressurized. In some embodiments, the exterior of the exemplary space vehicle (e.g., the perimeter of the panels 110, 120 described above) is hermetically sealed in order to allow the interior to be pressurized. In some embodiments the interior is pressurized to a pressure that is in a range of from 1 bar to 2 bar. In some embodiments, the interior is pressurized with a gas. In some embodiments, the gas is a convection gas. In some embodiments, the convection gas facilitates convection of heat within the space vehicle.

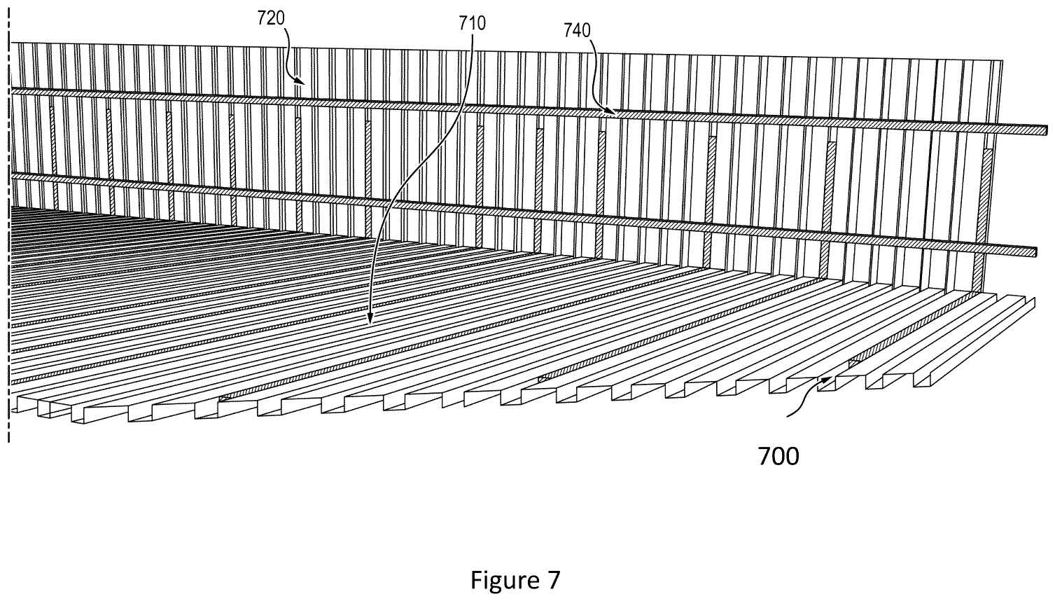

In some embodiments, the panels 110, 120 include grooves formed in surfaces that are configured to face the interior of the space vehicle 100. In some embodiments, the grooves 700 are configured (e.g., sized and shaped) to receive heat transport elements, such as heat pipes, therein. In some embodiments, the grooves 700 are sized and shaped to receive heat pipes that have a 11 mm to 15 mm square cross-section. In some embodiments, grooves 700 are also formed in the earth deck panel. FIG. 7 shows an exemplary panel 710 and earth deck panel 720 with grooves 700 formed therein. In some embodiments, such as shown in FIG. 7, the grooves 700 are oriented linearly, such as in parallel lines.

In some embodiments, heat transport elements, such as heat pipes, are embedded in at least some of the grooves 700. In the embodiment shown in FIG. 7, heat transport elements 740 are embedded in some of the grooves 700. In some embodiments, the heat transport elements 740 include copper-water heat pipes. In some embodiments, the heat transport elements 740 include carbon-ammonia heat pipes. In some embodiments, the heat transport elements include a carbon nanotube-based material. In some embodiments, the heat transport elements 740 include aluminum-ammonia heat pipes such as the heat pipes commercialized by Advanced Cooling Technologies of Lancaster, Pennsylvania, or by Euro Heat Pipes of Nivelles, Belgium. For clarity, FIG. 7 includes a reference numeral identifying a single one of the heat transport elements 740, but this term and the accompanying description refers to other exemplary heat pipes as well. In some embodiments, a heat spreader, such as a heat spreader made from carbon nanotubes, is used in place of the heat transport elements 740.

In some embodiments, the heat transport elements 740 are secured in the grooves 700 using a conductive filler. In some embodiments, a suitable conductive filler provides sufficient thermal conductivity to convey heat from a payload component located adjacent to one of the grooves 700 to one of the heat transport elements 740, and also provides sufficient adhesion to provide sufficient thermal conductivity while compensating for some degree of surface roughness either within the grooves 700 and/or on the surface of the heat transport elements 740. In some embodiments, the conductive filler has a thermal conductivity that is in a range of from 1 W/m/K to 30 W/m/K cross-plane (e.g., in a direction across the conductive filler between one of the heat transport elements 740 and the surface of a surrounding one of the grooves 700). In some embodiments, the conductive filler has a thermal conductivity that is in a range of from 100 W/m/K to 1,000 W/m/K in plane (e.g., in a direction along the conductive filler perpendicular to the cross-plane direction). In some embodiments, the conductive filler has sufficient adhesion to compensate for surface roughness that is in a range of from 0 microns (e.g., a perfectly smooth surface with no pores, gaps, etc.) to 500 microns. In some embodiments, suitable conductive fillers include the filler commercialized under the trade name MAPSIL by Map Space Coatings of Mazeres, France, the filler commercialized under the trade name SIGRAFLEX by SGL Carbon of Charlotte, North Carolina, the filler commercialized under the trade name T-PLI by Laird Technologies of Chesterfield, Missouri, and the filler commercialized under the trade name THERM-A-GAP by Parker Chomerics of Woburn, Massachusetts.

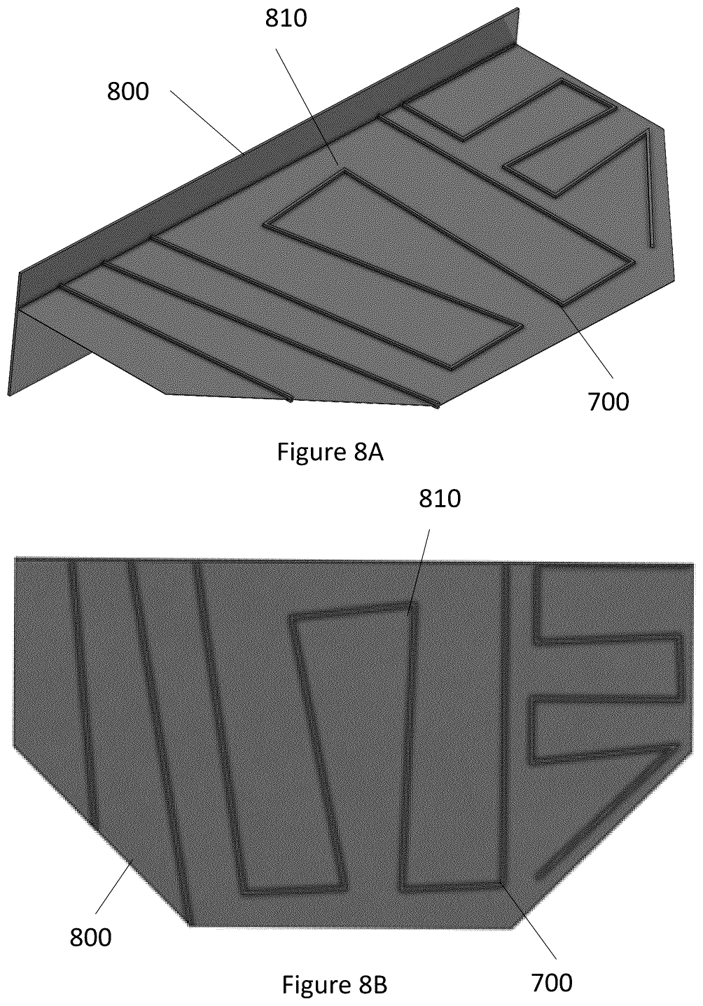

In some embodiments, the panels of an exemplary space vehicle include equipment fixation locations, which are locations to which equipment (e.g., platform elements and payloads) may be secured. FIGS. 8A and 8B shows a perspective view and a top view, respectively of an embodiment of an exemplary panel 800 having instrument fixation locations 810 and grooves 700 (only one of each of which is specifically identified in FIGS. 8A and 8B for clarity). In some embodiments, the grooves 700 are positioned proximate to (e.g., extending away from) the payload fixation locations 810 such that heat transport elements received therein will be thermally coupled to payload elements secured at the payload fixation locations 810, thereby to conduct heat away from such payload elements. In some embodiments, the space vehicle includes one or more radiators configured to radiate heat from the space vehicle into space. In some embodiments, the grooves 700 extend from the payload fixation locations 810 and toward a location from which heat is to be radiated, such as a radiator.

In some embodiments, an exemplary thermal control system includes corrugated surfaces. In some embodiments, an exemplary thermal control system includes corrugated radiators. In some embodiments, an exemplary thermal control system includes corrugated radiators positioned directly adjacent to heat transport elements to thereby allow heat within the heat transport elements to be directly conducted to the corrugated radiators. In some embodiments, an exemplary thermal control system includes corrugated radiators that are integrally formed with heat transport elements (e.g., heat pipes are positioned within corrugations of a corrugated radiator and/or heat transport elements are at least partially formed from the material of a corrugated radiator).

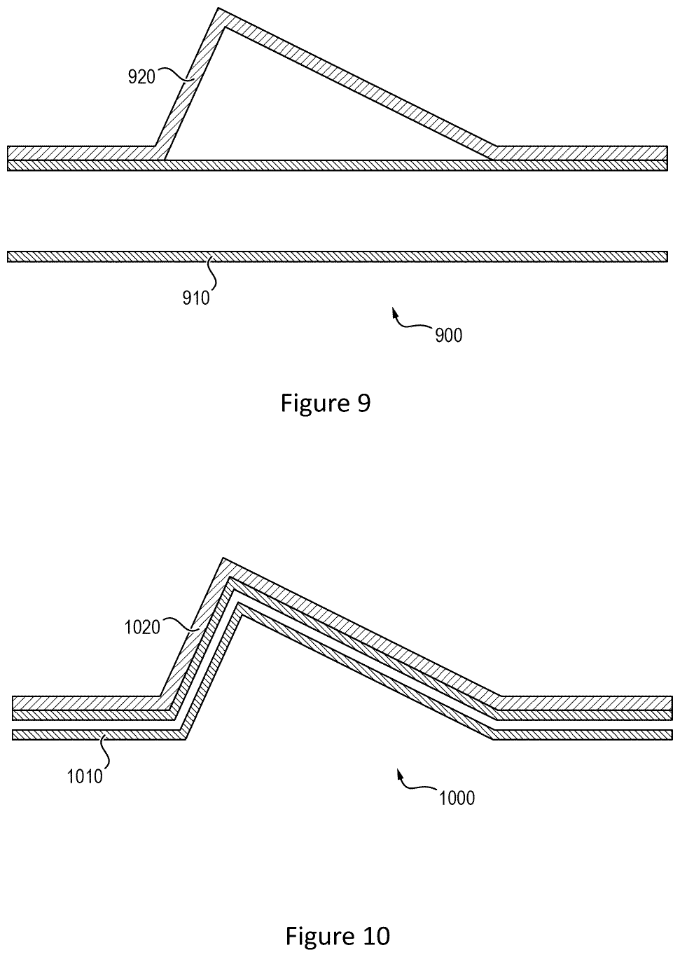

FIGS. 9-11 show exemplary embodiments of thermal control arrangements. FIGS. 9-11 include only a small portion of an actual implementation of a thermal control system, in that each figure shows a cross-sectional view of only one corrugation of a system that will include multiple corrugations. In some embodiments, an actual implementation including the thermal control arrangements shown in FIGS. 9-11 will include several of the corrugations adjacent to one another. Additionally, while FIGS. 9-11 show cross-sectional views, exemplary corrugations implemented into an exemplary space vehicle will have some depth in the view direction of the cross-sectional views shown in FIGS. 9-11. FIG. 12 shows a perspective view of an exemplary corrugated arrangement 1200 including five corrugations, shown in a manner so as to represent the depth of the corrugated arrangement 1200.

FIG. 9 shows an exemplary embodiment of a thermal control arrangement 900. The thermal control arrangement 900 includes a generally linear heat transport element 910. In some embodiments, the heat transport element 910 is a copper-water heat pipe. In some embodiments, the heat transport element 910 is a carbon-ammonia heat pipe. In some embodiments, the heat transport element 910 includes a carbon nanotube-based material. In some embodiments, the heat transport element 910 is an ammonium-aluminum heat pipe. In some embodiments, the heat transport element 910 is an oscillating heat pipe (“OHP”). The thermal control arrangement 900 also includes a corrugated radiator 920. In some embodiments, the corrugated radiator 920 is formed by press-forming as described above. In some embodiments, the corrugated radiator 920 is formed from a metal. In some embodiments, the corrugated radiator 920 is formed from an aluminum alloy. In some embodiments, the aluminum alloy is a 2000 series aluminum alloy, 6000 series aluminum alloy or a 7000 series aluminum alloy. In the embodiment shown in FIG. 9, the heat transport element 910 is oriented transversely to the corrugations of the corrugated radiator 920.

FIG. 10 shows an exemplary embodiment of a thermal control arrangement 1000. The thermal control arrangement 1000 includes a corrugated heat transport element 1010. In some embodiments, the heat transport element 1010 is a copper-water heat pipe. In some embodiments, the heat transport element 1010 is a carbon-ammonia heat pipe. In some embodiments, the heat transport element 1010 includes a carbon nanotube-based material. In some embodiments, the heat transport element 1010 is an ammonium-aluminum heat pipe. In some embodiments, the heat transport element 1010 is an oscillating heat pipe (“OHP”). The thermal control arrangement 1000 also includes a corrugated radiator 1020. In some embodiments, the corrugated radiator 1020 is formed by press-forming as described above. In some embodiments, the corrugated radiator 1020 is formed from a metal. In some embodiments, the corrugated radiator 1020 is formed from an aluminum alloy. In some embodiments, the aluminum alloy is a 2000 series aluminum alloy, 6000 series aluminum alloy or a 7000 series aluminum alloy.

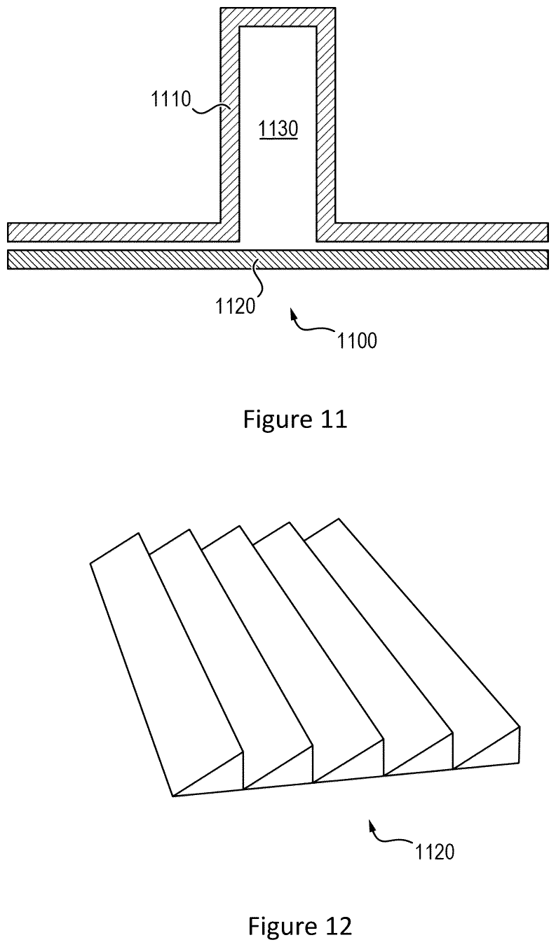

FIG. 11 shows an exemplary embodiment of a thermal control arrangement 1100. The thermal control arrangement 1100 includes a corrugated panel portion 1110 and an flat panel portion 1120 that is positioned adjacent to and underlying the corrugated panel portion 1110. In some embodiments, the corrugated panel portion 1110 and the flat panel portion 1120 are formed by press-forming as described above. In some embodiments, a gap 1130 is formed between the corrugated panel portion 1110 and the flat panel portion 1120. In some embodiments, the gap 1130 is filled with a heat-conductive liquid that is arranged so as to act as an OHP, thereby forming a heat transport element from the corrugated panel portion 1110, the flat panel portion 1120, and the heat-conductive liquid. In some embodiments, the heat-conductive liquid is a liquid having a thermal conductivity greater than 0.2 W/m K at standard temperature and pressure. In some embodiments, the heat-conductive liquid is ammonia. In some embodiments, the corrugated panel portion 1110 is formed from an aluminum alloy. In some embodiments, the corrugated panel portion 1110 is formed from a metal. In some embodiments, the corrugated panel portion 1110 is formed from an aluminum alloy. In some embodiments, the aluminum alloy is a 2000 series aluminum alloy, 6000 series aluminum alloy or a 7000 series aluminum alloy.

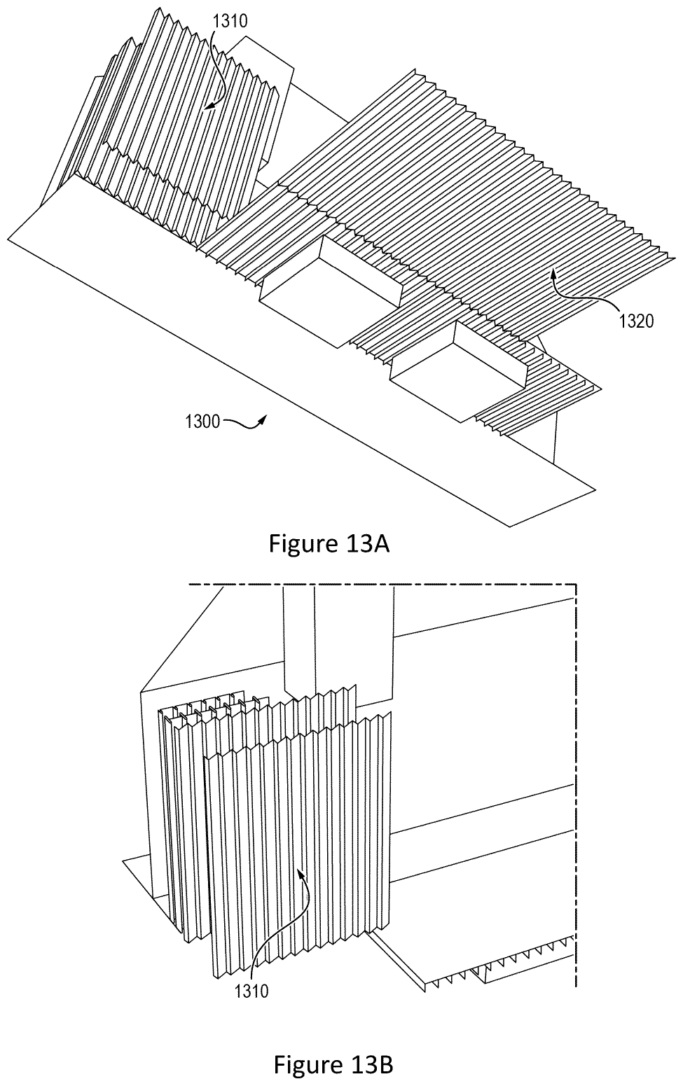

FIG. 13A shows a perspective view of an exemplary space vehicle 1300 having corrugated radiator regions 1310 and 1320. FIG. 13B shows an alternate perspective view of the corrugated radiator region 1310. As described above with reference to FIGS. 9-11, in some embodiments, the corrugated radiator regions 1310 and 1320 overlay heat transport elements so as to draw heat from such heat transport elements and radiate such heat into space.

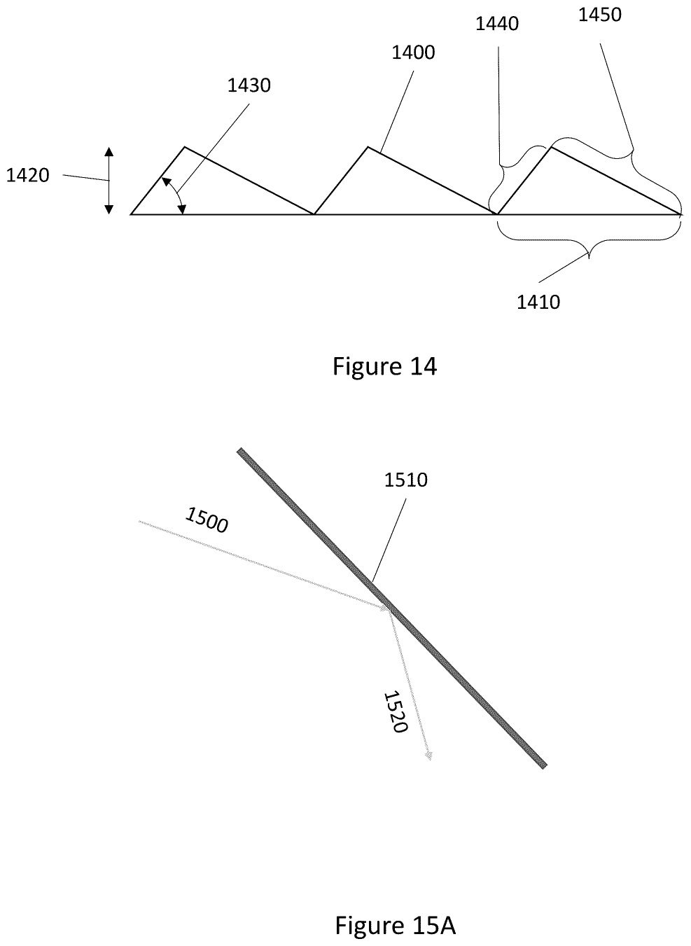

In some embodiments, the corrugations of a corrugated radiator as described herein are optimized to increase the heat dissipation capability of a radiator. In some embodiments, the use of a corrugated surfaces increases the equivalent heat dissipation area of a radiator. FIG. 14 shows a cross-sectional view of an exemplary corrugation pattern 1400 illustrating the increase in surface area of a corrugated radiator to thereby increase the heat distribution. The corrugation pattern 1400 shown in FIG. 14 is defined by a footprint length 1410, a height 1420, and an angle 1430. The footprint length 1410, height 1420, and angle 1430 combine to produce corrugations having a first side length 1440 and a second side length 1450, the sum of which is the effective length of the corrugation pattern 1400. In some embodiments, for a given footprint length 1410, the effective length can be tuned by selecting the height 1420 and the angle 1430. In some embodiments, for given values of the footprint length 1410 and the height 1420, the angle 1430 can be selected to increase the effective surface area (e.g., the sum of the first side length 1440 and the second side length 1450) by a ratio of 1+√2 (i.e., about 2.41) as compared to the footprint length 1410. In some embodiments, such an increase in effective surface area thereby increases the heat dissipation capability of such a radiator by the same ratio as compared to a planar radiator of the same size.

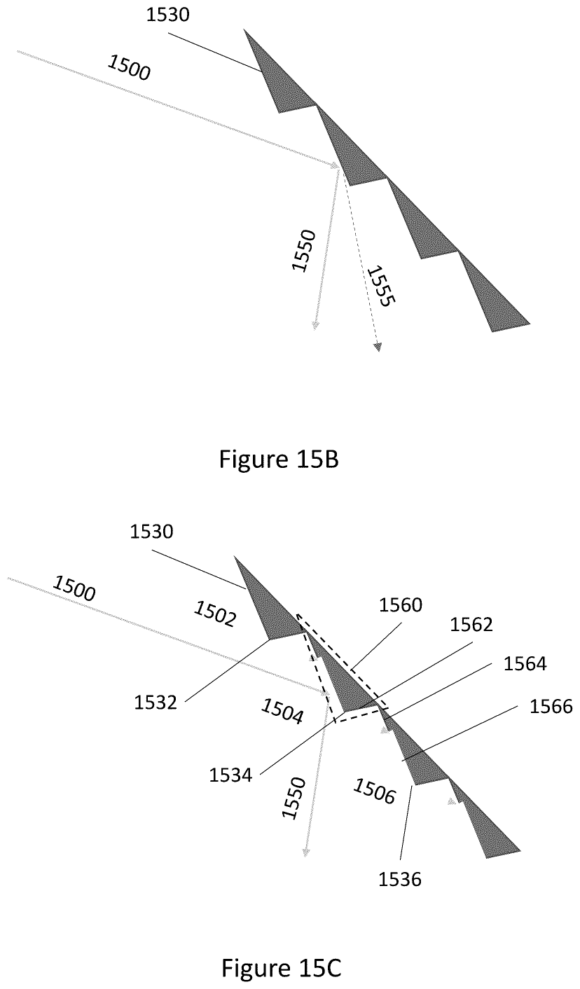

In some embodiments, a corrugated radiator is optimized to increase heat dissipation capability as described above with reference to FIG. 14, and also to limit the brightness of a satellite as viewed from an observer on the ground. FIG. 15A shows reflection of sunlight off a flat surface. As shown in FIG. 15A, incident sunlight 1500 reflects off a flat surface 1510 to produce reflected sunlight 1520 that projects toward an observer on Earth. FIG. 15B shows reflection of the same incident sunlight 1500 off a corrugated surface (e.g., a surface having corrugations similar to the corrugation pattern 1400 described above with reference to FIG. 14. As shown in FIG. 15B, a surface includes corrugations 1530 similar to the corrugation pattern 1400 described above with reference to FIG. 14. As a result of the presence of the corrugations 1530, the incident sunlight 1500 reflects off the corrugations 1530 to produce reflected sunlight 1550 that projects away from Earth; no reflected sunlight projects in a direction 1555 toward Earth that is the same direction as the direction of the reflected sunlight 1520 shown in FIG. 15A.

In addition to reflecting sunlight away from an observer on Earth, in some embodiments, a corrugated radiator reduces the proportion of a radiator surface on which the sun reflects. FIG. 15C shows additional detail of the manner in which sunlight is incident upon a surface including the corrugations 1530 shown in FIG. 15B. FIG. 15C shows the incident sunlight 1500 projecting in the same direction as shown in FIGS. 15A and 15B, and also shows additional parallel rays 1502, 1504, 1506. As shown in FIG. 15C, the rays 1502, 1504, and 1506 are defined by respective peaks 1532, 1534, 1536 of the corrugations 1530. Each of the peaks 1532, 1534, 1536 obstructs a portion of its own corrugation as well as a portion of a subsequent corrugation such that the sunlight only shines on a portion of each corrugation. For example, referring to a corrugation 1560 that includes the peak 1534, the peak 1534 obstructs the sunlight from shining on a shaded portion 1562 of the corrugation 1560 as well as on a shaded portion 1564 of an adjacent corrugation, leaving only an exposed portion 1566 of the adjacent corrugation exposed to the sunlight. As such, the portion of the corrugations 1530 reflecting the sun is reduced as compared to, for example, a flat surface 1510 as described above with reference to FIG. 15A. As a result, in some embodiments, the corrugations 1530 reduce solar flux received by a radiator including the corrugations 1530.

In some embodiments, a corrugated radiator includes corrugations have a shielding angle that is selected to allow a white painted Earth deck with low reflection to the ground or a black coated Earth deck with low incidence of solar flux for a worst hot case beta angle. In some embodiments, the shielding angle is in a range of from 20 degrees to 40 degrees, or is in a range of from 25 degrees to 35 degrees, or is about 30 degrees, or is 30 degrees.

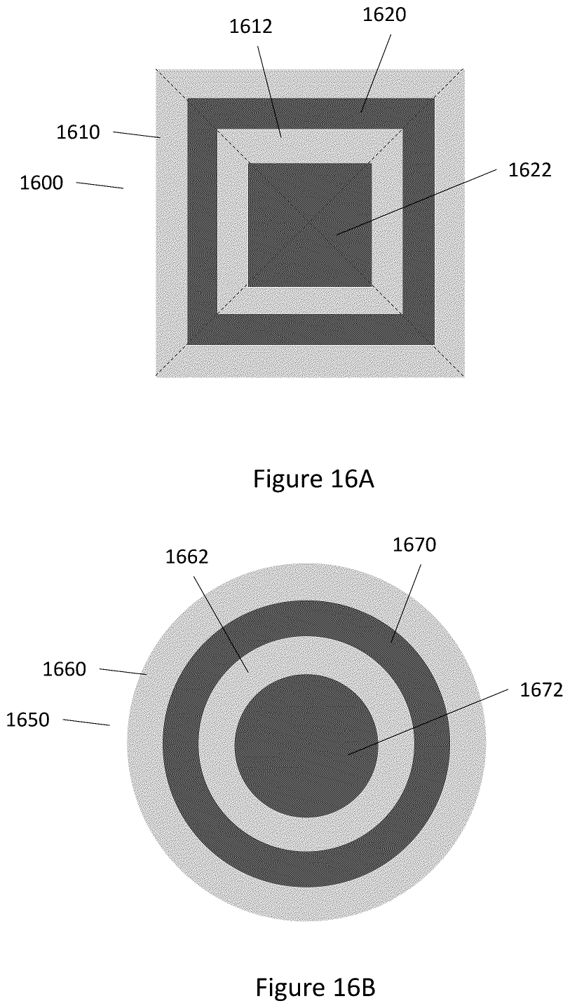

In some embodiments, such as described above with reference to FIGS. 12, 13A, and 13B, a corrugated radiator includes a linear corrugation pattern (e.g., a pattern including a series of parallel corrugations). In other embodiments, a corrugated radiator includes a two-dimensional corrugation pattern. FIG. 16A shows a top view of an embodiment of a corrugated radiator 1600 having a square pattern defined by alternating rising portions 1610, 1612 (e.g., analogous to the portions identified with reference numeral 1440 in FIG. 14) and descending portions 1620, 1622 (e.g., analogous to the portions identified with reference numeral 1450 in FIG. 14). FIG. 16B shows a top view of a corrugated radiator 1650 having a circular pattern defined by alternating rising portions 1660, 1662 (e.g., analogous to the portions identified with reference numeral 1440 in FIG. 14) and descending portions 1670, 1672 (e.g., analogous to the portions identified with reference numeral 1450 in FIG. 14). The specific patterns of the corrugated radiators 1600 and 1650 shown in FIGS. 16A and 16B, respectively, are only exemplary, and other embodiments of corrugated radiators may have differing two-dimensional patterns without departing from the broader principles described herein.

In some embodiments, any of the heat transport elements described herein (e.g. the heat transport elements 740, 910, and 1010) has a heat flux density that is in the range of from 2 W/m² to 20 W/m², or is in the range of from 2 W/m² to 10 W/m², or is in the range of from 5 W/m² to 20 W/m², or is in the range of from 5 W/m² to 10 W/m². In some embodiments, any of the heat transport elements described herein (e.g. the heat transport elements 740, 910, and 1010) has a thermal conductivity that is greater than 1,000 W/m/K, or is greater than 2,000 W/m/K, or is greater than 3,000 W/m/K, or is between 1,000 W/m/K and 100,000 W/m/K, or is between 2,000 W/m/K and 100,000 W/m/K, or is between 3,000 W/m/K and 100,000 W/m/K. In some embodiments, any of the heat transport elements described herein (e.g. the heat transport elements 740, 910, and 1010) has a heat transport capacity that is in the range of from 10 W to 1,000 W, or is in the range of from 50 W to 1,000 W, or is in the range of from 10 W to 500 W, or is in the range of from 50 W to 500 W, or is in the range of from 10 W to 300 W, or is in the range of from 50 W to 300 W. In some embodiments, any of the heat transport elements described herein (e.g., the heat transport elements 740, 910, and 1010) has a cross-sectional size (e.g., an exterior side length of a square heat pipe or an exterior diameter of a circular heat pipe) that is in the range of from 5 mm to 50 mm, and can have a cross-sectional size selected based on the amount of heat required to be conveyed thereby. In some embodiments, any of the heat transport elements described herein (e.g., the heat transport elements 740, 910, and 1010) is linear, L-shaped, U-shaped, or has a more complex shape, in order to allow for such heat transport elements to be positioned and to convey heat from and to appropriate locations within a satellite structure (e.g., from a payload component to a radiator).

In some embodiments, an exemplary space vehicle is made by a process including providing a quantity of sheet aluminum; forming at least a first panel and a second panel from the sheet aluminum by press-forming, wherein the first panel includes a groove formed therein; positioning a heat transport element in the groove; forming a radiator overlaying the heat transport element; providing at least one onboard equipment component, wherein the at least one onboard equipment component has no outer casing; fixing the at least one onboard equipment component to the first panel so as to overlay the heat transport element; and sealing the first panel to the second panel to form the space vehicle.

By incorporating grooves for receiving heat transport elements directly into the material of the panels (e.g., by forming such grooves by stamping the material of the panels), heat transport elements may be incorporated where appropriate and without inclusion of additional elements to accommodate the heat transport elements. Additionally, by positioning corrugated radiators directly over heat transport elements, radiation of heat generated by onboard equipment into space is improved.

While a number of embodiments of the present invention have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

What is claimed is:

1. A space vehicle, comprising:
a space vehicle body,
wherein the space vehicle body comprises an interior surface defining an interior of the space vehicle body and an exterior surface opposite the interior surface, and
wherein at least a portion of the space vehicle body comprises a panel comprising a sheet metal;
an onboard equipment component positioned within the interior of the space vehicle body;
a radiator positioned on the exterior surface of the space vehicle body,
wherein the radiator comprises a plurality of corrugations, and
wherein the plurality of corrugations are angled so as to reflect at least a portion of incident sunlight away from Earth; and
a heat transport element positioned along the interior surface of the space vehicle body so as to convey heat away from the onboard equipment component and toward the radiator.

2. The space vehicle of claim 1, wherein the heat transport element is oriented transversely to the plurality of corrugations of the radiator.

3. The space vehicle of claim 1, wherein the heat transport element is oriented along the plurality of corrugations of the radiator.

4. The space vehicle of claim 1, wherein the heat transport element is positioned within one of the plurality of corrugations of the radiator.

5. The space vehicle of claim 1, wherein the heat transport element is defined by a material of the radiator and a material of the panel underlying the material of the radiator.

6. The space vehicle of claim 5, wherein the heat transport element further comprises a heat-conductive liquid positioned within a space defined between the material of the radiator and the material of the panel.

7. The space vehicle of claim 6, wherein the heat-conductive liquid has a thermal conductivity greater than 0.2 W/m K at standard temperature and pressure.

8. The space vehicle of claim 6, wherein the heat-conductive liquid comprises ammonia.

9. The space vehicle of claim 1, wherein the heat transport element comprises a heat pipe.

10. The space vehicle of claim 9, wherein the heat pipe comprises at least one of a copper-water heat pipe, a carbon-ammonia heat pipe, or an aluminum-ammonia heat pipe.

11. The space vehicle of claim 1, wherein the heat transport element comprises a carbon nanotube-based material.

12. The space vehicle of claim 1, wherein the heat transport element has a heat flux density that is in a range of from 2 W/m² to 20 W/m².

13. The space vehicle of claim 1, wherein the heat transport element has a thermal conductivity that is at least 1,000 W/m/K.

14. The space vehicle of claim 1, wherein the heat transport element has a heat transport capacity that is a range of from 10 W to 1,000 W.

15. The space vehicle of claim 1, further comprising a conductive filler positioned between the heat transport element and the interior surface of the space vehicle body so as to adhere the heat transport element to the interior surface of the space vehicle body.

16. The space vehicle of claim 15, wherein the conductive filler has a thermal conductivity that is in a range of from 100 W/m/K to 1,000 W/m/K in plane.

17. The space vehicle of claim 1, wherein the plurality of corrugations are further angled so as to reduce a proportion of incident sunlight that shines on the radiator.

18. The space vehicle of claim 1, wherein the onboard equipment component is one of a platform equipment component or a payload component.
